(19) United States
(12) Patent Application Publication
(10) Pub. No.: US 2003/0099475 A1
(43) Pub. Date: May 29, 2003

(54) Controlling system for use with variable attenuators

(75) Inventors: Nobuyuki Nemoto, Kawasaki (JP); Taro Asao, Kawasaki (JP); Kazuo Tanaka, Kawasaki (JP); Kazunori Horachi, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/078,488

(22) Filed: Feb. 21, 2002

(30) Foreign Application Priority Data
Nov. 28, 2001 (JP) 2001-362252

(51) Int. Cl. H04J 14/02

(52) U.S. Cl. 398/83

(57) ABSTRACT

At an optical node, variable attenuators VAT 1 to VAT n, TAP 11-1 to TAP 11-n, and photo detectors PD 1 to PD n are disposed corresponding to paths of optical signal components of individual wavelengths that are demultiplexed from a WDM optical signal and that are switched. The TAP 11-1 to TAP 11-n monitor output optical levels of the variable attenuators VAT 1 to VAT n, respectively. The monitored results are processed by a feed-back circuit and output as control signals of the variable attenuators VAT 1 to VAT n.

### BACKGROUND OF THE INVENTION

1. Field of the Invention

The present invention relates to a controlling system, used with a variable attenuator disposed in a WDM (Wavelength Division Multiplexing) transmitting apparatus, for compensating the fluctuation of optical power levels of optical signal components of individual wavelengths, controlling an optical output, performing a protection switch in an optical level, preventing an optical output from surging, and preventing a miss-connection from taking place.

2. Description of the Related Art

FIG. 1 is a block diagram showing the structure of a conventional WDM transmitting apparatus.

The WDM transmitting apparatus shown in FIG. 1 uses an SAU (Spectrum Analyzer Unit) that adjusts optical output powers of optical signal components of individual wavelengths in a predetermined level so as to control VATs (Variable Attenuators) disposed on the preceding stage thereof. However, when a protection switch of an optical network is structured with the system, the response speed at which the protection switch is executed in an optical level is slow. Thus, the system does not satisfy the requirement of 50 ms. or less for the protection switch by ITU and so forth. In addition, since the SAU is expensive, the system adversely affects the cost budget.

Next, a problem to be solved by the present invention will be described with reference to a block diagram of a conventional WDM transmitting apparatus shown in FIG. 1.

A WDM optical signal of which n waves have been multiplexed is input to a pre-amplifier (pre-AMP) disposed on a first stage shown in FIG. 1. The optical power level of the WDM signal is weak due to a loss through an optical transmission line. The pre-AMP amplifies the weak optical signal to a predetermined level. The amplified WDM signal is supplied to a DEMUX. The DEMUX demultiplexes the amplified WDM signal to optical signal components of individual wavelengths. The demultiplexed optical signal components are branched to two ways. As the first way, the optical signal components are supplied to VATs on the next stage (the optical signal components are passed through the apparatus) As the second way, the optical signal components are supplied to transponder units (TRPNs) (the optical signal components are dropped to the apparatus). The optical signal components supplied to the TRPNs are connected in such a manner that a SONET signal is supplied to a SONET unit and a Gigabit Ethernet signal is supplied to a unit that processes the signal.

The spectrum of the optical signal components that are passed through the apparatus and supplied to the VATs is measured by a SAU disposed downstream of the VATs. To suppress the fluctuation (tilt) of powers of optical signal components of individual wavelengths, a control signal corresponding to the result measured by the SAU is fed back to the VATs assigned for optical signal components of individual wavelengths so as to compensate the optical power levels of the optical signal components of individual wavelengths. The SAU can detect the spectrum of the optical signal components of individual wavelengths of the input WDM signal and monitor the optical powers of the optical signal components of individual wavelengths.

The VATs are controlled with the detected result so as to suppress the tilt of the powers of the optical signal components of individual wavelengths. Thereafter, an MUX multiplexes n wavelengths and inputs the multiplexed signal to a post-AMP (post-amplifier) disposed on the next stage. The post-AMP performs ALC (Automatic Level Control) for automatically controlling the gain of the multiplexed signal so that a predetermined output power is obtained. The amplified signal is branched to two ways. As the first way, the amplified signal is supplied to the SAU for a feedback loop that suppresses the tilt. As the second way, the multiplexed signal is output to a network and connected to a WDM transmitting apparatus disposed at the next node. The conventional apparatus operates in such a manner.

However, the conventional apparatus has the following problems.

1. To compensate the tilt of optical powers of optical signal components of individual wavelengths, it is always necessary to measure the levels of the optical powers of the optical signal components of individual wavelengths. As was described above, conventionally, the role was performed with an SAU shown in FIG. 1. However, the SAU analyzes the spectrum of light of an WDM signal. With the analyzed spectrum components, optical powers are obtained. To use such a technology, the cost was very high (around ¥ 2,000,000 on PIU (Plug In Unit) basis). Thus, the apparatus has a problem from a view point of cost.

2. Conventionally, with respect to the fluctuation of characteristics of optical devices such as a DEMUX, an MUX, post/pre-AMP, and so forth and the fluctuation of the levels of optical powers of optical signal components of individual wavelengths due to different transmission paths such as different light sources for example through light and add light, the optical powers of optical signal components of individual wavelengths are measured with a SAU. The measured result is fed back to VATs disposed on the preceding stage of the SAU so as to compensate the fluctuations. In this case, the tilt of the optical powers of optical signal components of individual wavelengths can be compensated with the measured result that is fed back from the SAU. However, since the SAU is always required, the apparatus is very disadvantageous from a view point of cost. In addition, when the wavelength multiplexing ratio of a WDM optical signal varies, since the input level of all the optical power of a post-AMP fluctuates, two types of operation sequences are required. The first operation is an ALC operation and the second operation is an AGC operation. Thus, when the number of nodes connected to the apparatus is large, it takes a long time to start up the apparatus.

3. FIGS. 2 and 3 are schematic diagrams for explaining a protection switch of an optical network. Conventionally, as shown in FIG. 2, a protection switch that is performed in an optical level supports only OUPSR (Optical Uni-directional Path Protection Ring) of which the same signal always flows on a work path and a protection path. Thus, even if a protection switch is required due to a fault or the like, it can be accomplished in such a manner that the SAU detects the increase or decrease of the number of wavelengths and the gain of the optical amplifier is set to a predetermined level corresponding to the detected result. Thus, it does not take a long time to switch the work path to the protection switch (except for a time required for an optical switch on the reception end). However, as shown in FIG. 3, in the case of OSPPR (Optical Shared Path Protection Ring) that is another protection switch structure, since the protection path is shared by communication nodes (nodes F and E) other than communication nodes (nodes A and D). Thus, the protection path should be always kept in an idle state. Consequently, the optical amplifier should wait without an input signal (only when another node does not use the path). When a protection switch takes place in such a state, if the optical amplifier of each node is restarted after the SAU detects the presence/absence of a wavelength, as the number of ring nodes increases, it becomes impossible to switch the work path to the protection path in 50 ms or less. Since the SAU has an internal structure of which a predetermined wavelength band is repeatedly and mechanically swept for peak values so as to detect optical powers of optical signal components of individual wavelengths, the operation of the apparatus becomes slow.

4. When a feed-back control is performed by a SAU and VATs as shown in FIG. 1, if no signal is input to a VAT, it does not output a signal. Thus, a feed-back signal that is output from the SAU becomes a command that causes the attenuation amounts of the VAT to be minimized (namely, the VAT becomes an open state). For example, when the DEMUX and a VAT are connected through an optical fiber line as shown in FIG. 1, if an optical fiber line is disconnected due to any particular cause, the input of the VAT becomes a disconnected state. As a result, such an operation takes place. Thus, in the state that the attenuation amount of a VAT is 0, when an optical fiber line that outputs an optical signal is connected after the system is recovered from a fault, a large optical signal is instantaneously input to an optical amplifier disposed on the next stage of the VAT. As a result, the optical amplifier outputs a very large optical surge. When the next node receives such a large optical surge, an optical device (for example, a pre-AMP in the case shown in FIG. 1) may be destroyed. On the other hand, to prevent the optical surge from being output, when an optical input signal is disconnected, the attenuation amount of the VAT may be forcedly maximized. In this case, since the attenuation amount of the VAT is maximized, an optical signal is not input to a PD disposed on the next stage forever. In other words, even if the system is recovered from a fault, since the WDM transmitting apparatus disposed on the next stage does not have a means for detecting the recovery from the fault, the apparatus adjusts the optical power level assuming that the fault still takes place. As a result, an improper optical power level remains. In other words, since an optical power level cannot be correctly detected, the system cannot be automatically recovered from a fault.

5. When a network is structured with OSPPR as shown in FIG. 3, to effectively use a protection path, it can be used as a PCA line by others. Normally, the protection path is in an idle state. FIG. 4 shows an example of the structure of a switch fabric used in a WDM transmitting apparatus. In the switch fabric, to reduce the cost, as many optical components as possible are reduced. In an apparatus with such a structure, when an application on the client side (the node A shown in FIG. 3) of the OSPPR network is structured in the 1+1 structure, even if a (1×2 SW-B) is switched to either way, an improper optical signal is adversely output to the network side. In addition, when ASE light is output to a path that is not used, an optical power level that does not correspond to the number of wavelengths takes place. Thus, when a pre-AMP of the next node is activated, the gain of the amplifier cannot be accurately set (because the input optical power corresponding to the number of wavelengths is different from the real power). In addition, when a protection path is used as a PCA at another node in the OSPPR structure shown in FIG. 5, if a protection switch takes place, depending on the transition state of the switch of each node, a miss-connection as shown in FIG. 5 adversely takes place.

6. As a means for solving the problem 5, a VAT assigned for the protection path side of the node A shown in FIG. 1 may be set to the maximum attenuation amount. In this case, the SAU should monitor the optical power level after the VAT has been controlled. Thus, the SAU monitors the optical power on the next stage of the VAT. When the VAT is forcedly turned off (to the maximum attenuation amount), even if an optical signal is input to the VAT, since the SAU cannot monitor the optical power (because the VAT are forcedly turned off), the regular feed-back operation is not performed. Thus, the attenuation amount of the VAT becomes the maximum and thereby a signal cannot be transmitted. However, when the forced off-state of the VAT is cleared, there is a possibility of which a large optical signal is instantaneously output from the VAT. When the large optical signal is input to the optical amplifier, a surge takes place. Thus, there is a possibility of which the surge destroys the optical amplifier disposed on the next stage.

### SUMMARY OF THE INVENTION

An object of the present invention is to provide a controlling system for use with a variable attenuator disposed in an optical circuit system in such a manner that the optical circuit system can be operated at high speed at low cost.

The present invention is a controlling system for use with variable attenuators disposed in a WDM transmitting apparatus for adding and dropping a WDM optical signal, the controlling system comprising a plurality of variable attenuators for adjusting optical power levels of optical signal components of individual wavelengths demultiplexed from the WDM optical signal, a plurality of output optical level detecting units detecting the output optical levels of the plurality of variable attenuators, and a feed-back circuit for controlling adjustments of the optical attenuation amounts of the plurality of variable attenuators, wherein optical signal components of individual wavelengths whose power levels have been adjusted by the plurality of variable attenuators are multiplexed and thereby a WDM optical signal is generated and transmitted.

According to the present invention, optical power levels of optical signal components of individual wavelengths of a WDM signal are adjusted without need to use a spectrum analyzer. Thus, the cost of the apparatus can be reduced. In addition, the control of an optical attenuator can be quickly performed as the state of an optical signal varies.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a block diagram showing the structure of a conventional WDM transmitting apparatus;

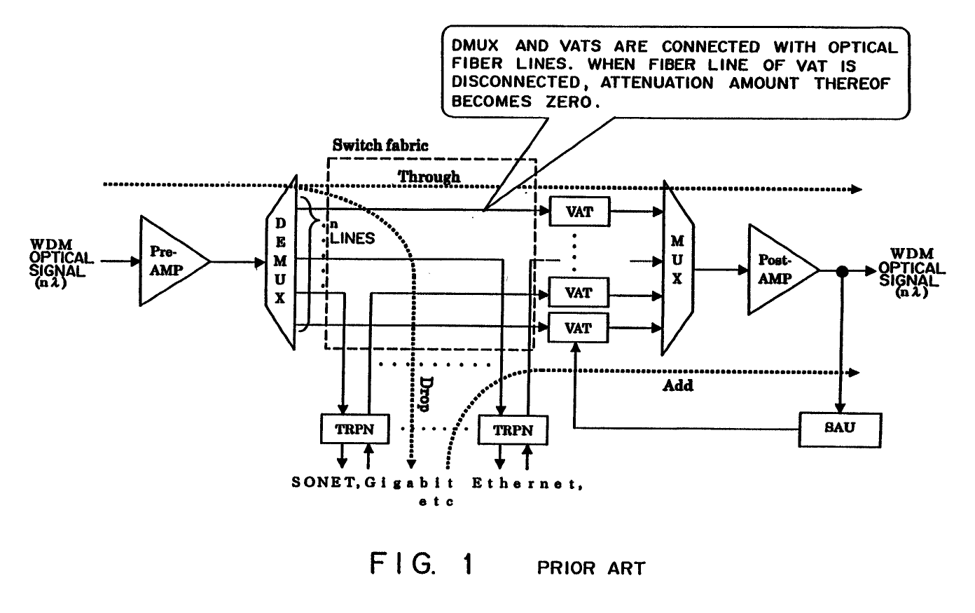

FIG. 2 is a schematic diagram for explaining a protection switch for an optical network (No. 1);

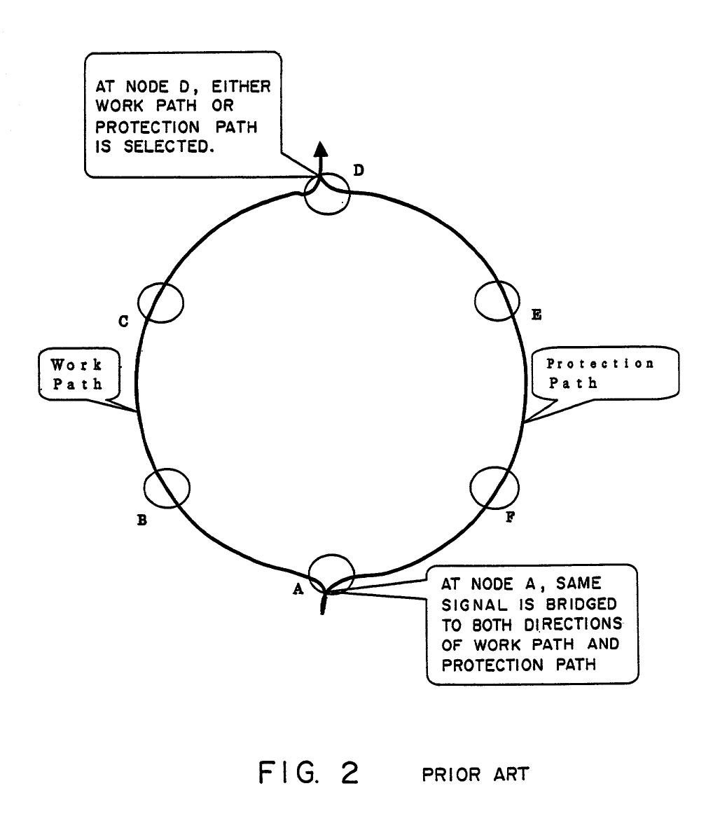

FIG. 3 is a schematic diagram for explaining a protection switch for an optical network (No. 2);

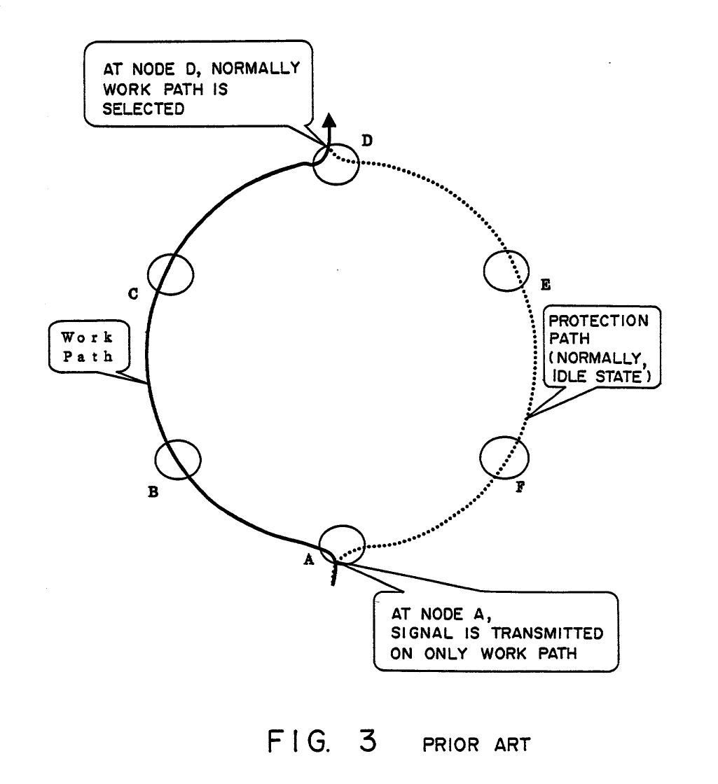

FIG. 4 is a schematic diagram showing an example of the structure of a switch fabric disposed in a WDM transmitting apparatus;

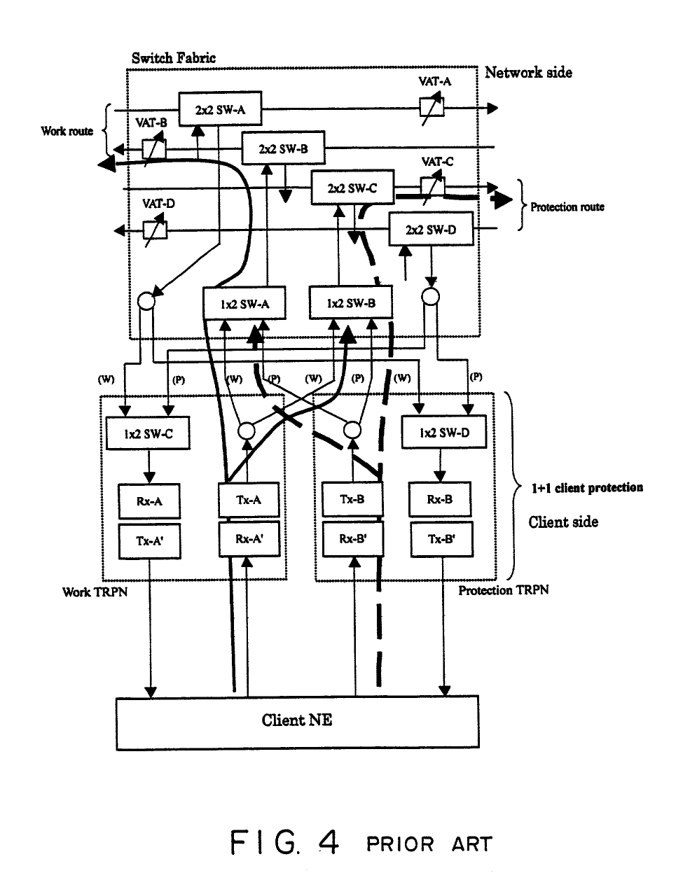

FIG. 5 is a schematic diagram for explaining a problem that takes place in OSPPR structure when a protection path is used as a PCA at another node;

FIG. 6 is a block diagram showing a part of a WDM transmitting apparatus according to an embodiment of the present invention;

FIG. 7 is a block diagram showing a WDM transmitting apparatus according to an embodiment of the present invention;

FIG. 8 is a block diagram showing a WDM transmitting apparatus according to another embodiment of the present invention;

FIG. 9 is a flow chart showing a VAT controlling process according to an embodiment of the present invention (No. 1);

FIG. 10 is a flow chart showing a VAT controlling process according to an embodiment of the present invention (No. 2);

FIG. 11 is a flow chart showing a VAT controlling process according to an embodiment of the present invention (No. 3); and

FIG. 12 is a flow chart showing a VAT controlling process according to an embodiment of the present invention (No. 4).

### DESCRIPTION OF PREFERRED EMBODIMENTS

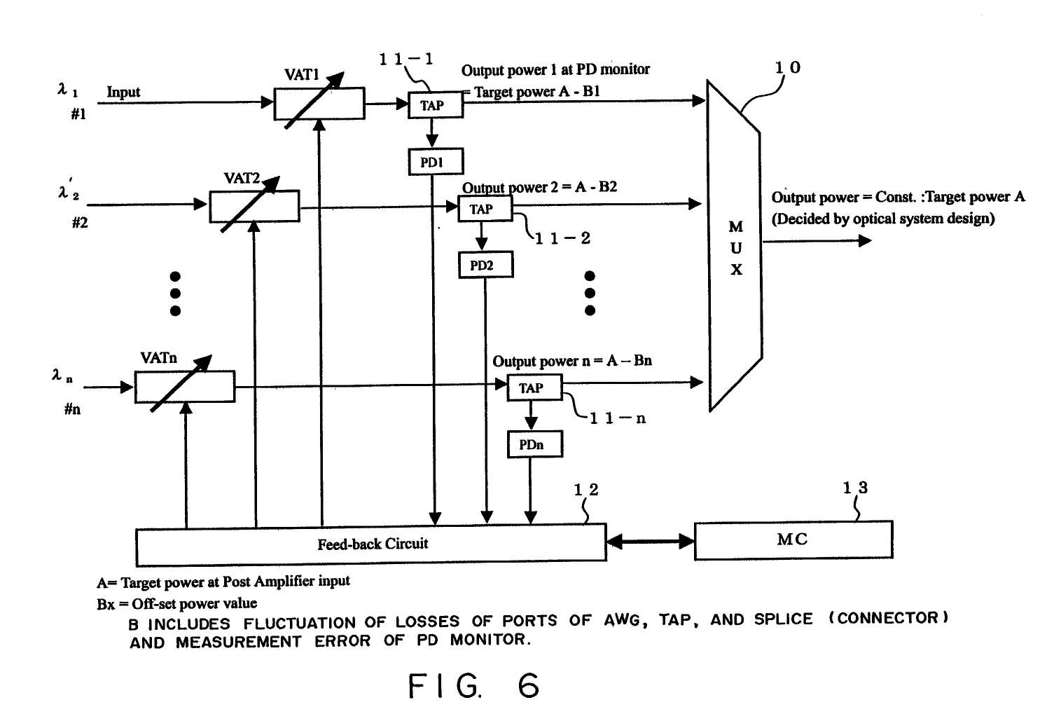

FIG. 6 is a block diagram showing a part of a WDM transmitting apparatus according to an embodiment of the present invention.

VAT 1 to VAT n and PD (Photo Detector) 1 to PD n are disposed on the preceding stage of a MUX 10. The VAT 1 to VAT n adjust optical power levels of the optical signal components. The PD 1 to PD n monitor the optical power levels of the optical signal components. The MUX 10 multiplexes wavelengths of the optical signal components. Optical attenuation amounts of the VAT 1 to VAT n are adjusted by a feed-back circuit 12 so that the optical power levels of the optical signal components of individual wavelengths branched by TAP 11-1 to TAP 11-n that are light branching means become target values corresponding to information monitored by the PD 1 to PD n.

The optical powers of optical signal components of individual wavelengths of a multiplexed optical signal that is output from the MUX 10 fluctuates (tilts) because losses of the optical multiplexer (MUX), the optical demultiplexer (DMUX), and other optical devices fluctuate. When the multiplexed optical signal is further transmitted through a transmission path, the optical powers further tilt, resulting in adversely affecting the setting of the gain of the optical amplifier. Finally, it becomes difficult for the reception end to obtain the optical signal in its dynamic range. As a result, there is a probability of which an error of a main signal will take place. As a method for solving such a problem, VATs and PDs are disposed as shown in FIG. 6 and the attenuation amounts of the VATs are variably adjusted corresponding to information monitored by the PDs so that the optical output powers of optical signal components of individual wavelengths of the multiplexed optical signal that is output from the MUX do not fluctuate. In addition, an optical attenuation amount that is (compensated value of fluctuation+particular value) for each of optical signal components of individual wavelengths is stored to the apparatus. As a result, a signal with a predetermined optical power can be input to the post-AMP disposed on the next stage. Consequently, since the SAU can be omitted, the apparatus becomes very advantageous from a view point of cost.

In the structure using such VATs and PDs, target optical power levels are pre-stored to a memory such as EEPROM of the WDM transmitting apparatus. The PDs are always monitored. When a monitored value of a PD fluctuates (namely, the optical power level that is input to the corresponding VAT fluctuates), the attenuation amount of the VAT is adjusted so that the optical power is corrected to the stored target value. A controlling method of which even if an input optical level fluctuates, an output optical level always becomes constant is called ALC control. When the ALC control is accomplished by VATs and PDs, it is not necessary to control the gain of the post-AMP disposed on the next stage. In addition, since it is not necessary to perform the ALC operation on the stage of the post-AMP, the network can be quickly started up. Moreover, since the SAU can be omitted, the apparatus becomes very advantageous from a view point of cost.

When the SAU is omitted and the feed-back control is performed with VATs and PDs, the operation can be performed in around 5 ms in comparison with the case that the operation performed by the SAU requires around 100 ms. Thus, the protection switch time necessary to switch the work path to the protection path of the OSPPR network can be decreased to as short as 50 ms or less. Thus, the value required by ITU and so forth can be satisfied.

As shown in FIG. 6, VATs and PDs are disposed on the preceding stage of an MUX. When an output optical level monitored by a PD is lower than a predetermined input off threshold value level, the apparatus determines that the input is disconnected. A feed-back circuit issues a command that causes the attenuation amount of the VAT to be adjusted to a predetermined fixed value (ALD (Automatic Level Down) function). It is defined that “predetermined fixed value” is a value that is sufficiently small as an output optical signal (of which an optical surge is not output from the post-AMP) and that when an optical signal is input to the VAT, the corresponding PD can sufficiently detect the optical signal. Thus, when an optical signal is input to the VAT, since it attenuates the optical power, the post-AMP is suppressed from outputting an optical surge. As a result, the optical amplifier disposed at the next node can be prevented from being destroyed by a large optical surge. In addition, since the PD can detect an optical signal, when an optical signal is input to the VAT portion, it can be automatically recovered (in this case, it is necessary to pre-set a recovery threshold value).

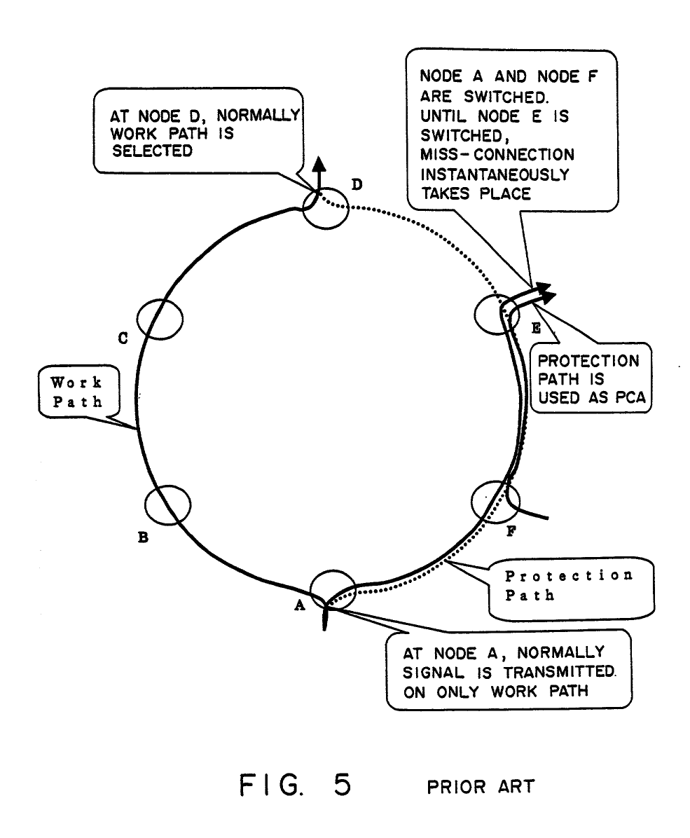

As shown in FIG. 6, when VATs are disposed on the preceding stage of the MUX and information that represents that a wavelength assigned to a particular VAT is not used is received from an MC (Management Complex) 13, with the maximum optical attenuation amount of the VAT, the optical signal that enters the VAT can be sufficiently attenuated. Thus, the post-AMP disposed on the next stage can be prevented from outputting an optical signal. When the optical signal is output, the gain of the pre-AMP of the next node cannot be accurately set (since the optical power corresponding to the number of wavelengths is different, an incorrect gain is set). As the result, the setting of the optical level is adversely affected and the quality of the main signal will be deteriorated. When the VAT is forcedly turned off (the attenuation amount is maximized), as were described in the section of “Description of the Related Art” and “Problem 5”, the problem of miss-connection shown in FIG. 5 can be solved.

In the case that the forced off control of a VAT is performed (with maximum attenuation amount), unlike with the ALD function, since the attenuation amount of the VAT is maximum, when an optical signal component of a wavelength assigned to the VAT for which the ALD control is performed is input, the PD disposed on the next stage of the VAT cannot detect the optical input. Thus, the VAT cannot be automatically recovered. However, when the forced off control is performed, since the wavelength is not used, if it is used, the MC 13 issues a relevant command. With the command as a trigger, the forced off state of the VAT can be cleared. In addition, when the forced off state is cleared, if the VAT is slowly operated (the attenuation amount is adjusted more slowly than usual), the fluctuation of the input power of the pre-AMP on at next node can be alleviated. As a result, the pre-AMP can be suppressed from outputting a surge signal. Consequently, an optical device disposed on the next stage can be prevented from being destroyed.

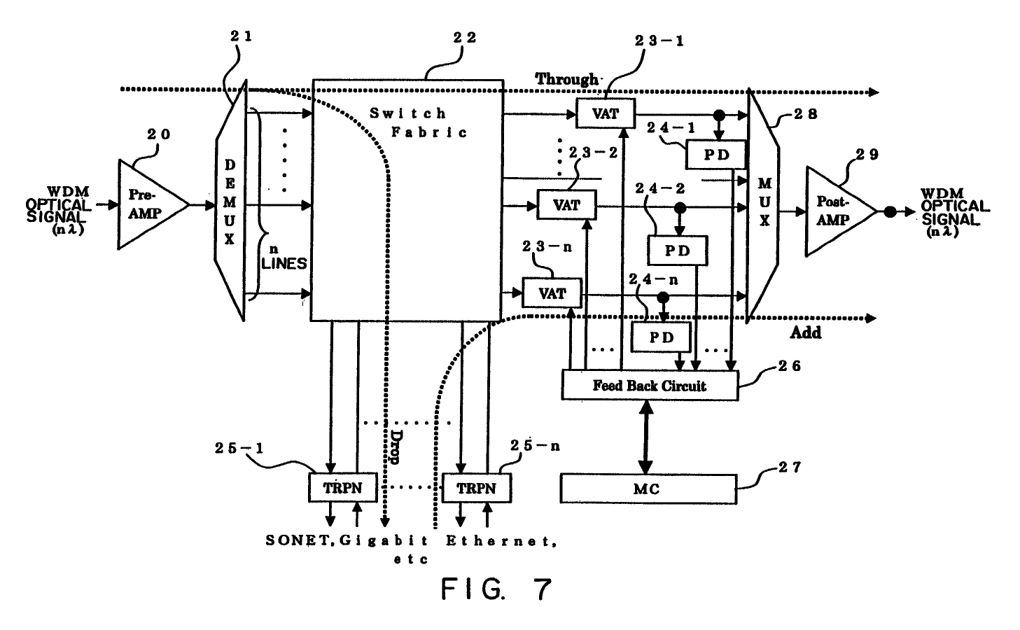

FIG. 7 is a block diagram showing a WDM transmitting apparatus according to an embodiment of the present invention.

A WDM signal of which n waves have been multiplexed and that is in a weak optical power level due to a loss through an optical transmission line is input from the left side of FIG. 7 to a pre-AMP (pre-amplifier) 20 disposed on the first stage. The pre-AMP 20 amplifies the weak optical signal to a signal having a predetermined constant level. A DEMUX 21 demultiplexes the amplified WDM signal into optical signal components of individual wavelengths and outputs the demultiplexed optical signal components to a switch fabric (SW-F) 22 disposed on the next stage. The SW-F 22 has an internal optical switch that branches the optical signal components to two ways. As a first way, the optical signal components are supplied to VAT 23-1 to VAT 23-n (the optical signal components are passed through the WDM transmitting apparatus). As a second way, the optical signal components are supplied to TRPN 25-1 to TRPN 25-n (the optical signal components are dropped to the WDM transmitting apparatus). The optical signal components supplied to the TRPN 25-1 to TRPN 25-n are connected in such a manner that a SONET signal is supplied to a SONET unit and a Gigabit Ethernet signal is supplied to a unit that processes the signal. The optical signal components passed to the VAT 23-1 to VAT 23-n are supplied to PD 24-1 to PD 24-n disposed on the next stage, respectively. The PD 24-1 to PD 24-n offset output optical levels and suppress the tilt thereof. Thus, the optical power levels of optical signal components of individual wavelengths are compensated. The optical powers detected by the PD 24-1 to PD 24-n are supplied to a feed-back circuit 26. The feed-back circuit 26 controls the VAT 23-1 to VAT 23-n so that predetermined optical output powers can be obtained.

In such a manner, the tilt of optical powers of optical signal components of individual wavelengths can be suppressed. In addition, the ALC operation can be performed. The VAT 23-1 to VAT 23-n can be controlled by an MC 27. Thereafter, an MUX 28 multiplexes n wavelengths. The multiplexed signal is input to a post-AMP (post-amplifier) 29 disposed on the next stage. The post-AMP 29 is operated by the AGC (Automatic Gain Control) from the beginning of the startup of the system since the input optical power level of the post-AMP 29 is always constant because of the structure of the VAT 23-1 to VAT 23-n and the PD 24-1 to PD 24-n disposed on the preceding stages of the post-AMP 29. The gain value used for the AGC operation is pre-stored in a memory of the WDM transmitting apparatus. An optical signal with a power corresponding to the gain value is output. The amplified signal is output to the network and connected to a WDM transmitting apparatus at the next node.

In addition, although optical switch portions are structured using passive devices, they may be structured using MEMS (Micro-Electro-Mechanical System) in the next generation.

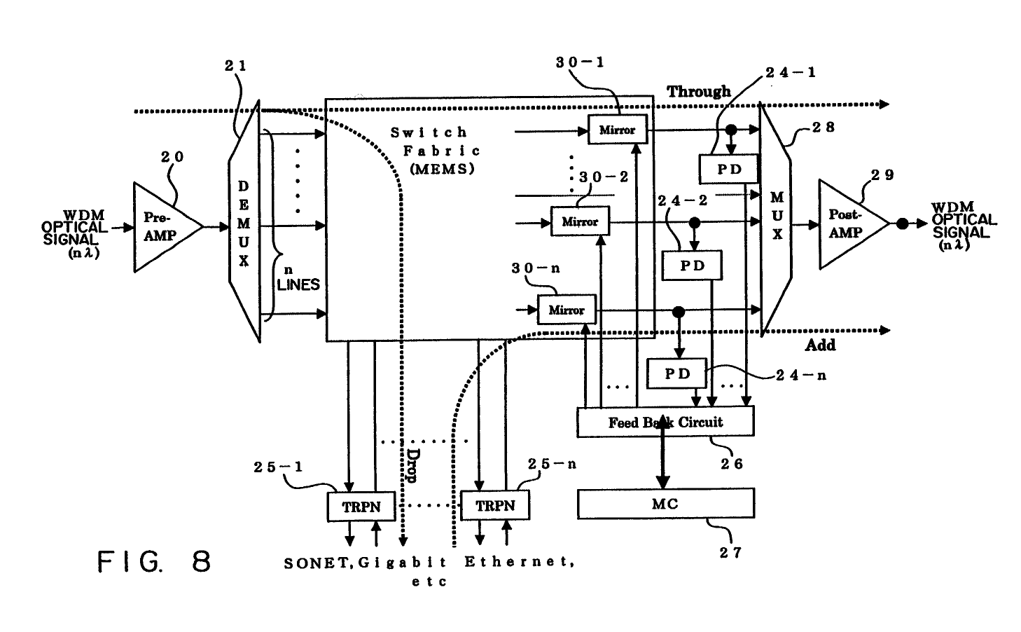

FIG. 8 is a block diagram showing a WDM transmitting apparatus according to another embodiment of the present invention.

For simplicity, in FIG. 8, similar portions to those in FIG. 7 are denoted by similar reference numerals and their description will be omitted.

As shown in FIG. 8, the VATs shown in FIG. 7 are substituted with an MEMS. The MEMS has both a switching function and an optical attenuating function. Thus, the attenuation characteristic of the MEMS can be used instead of the VATs. In the MEMS, the angle of each of internal mirrors 30-1 to 30-n are changed and the optical direction thereof is controlled, so that the exit to which the optical signal component is output can be selected. At that point, when the optical axis deviates, an optical loss takes place and thereby an attenuation characteristic as with a VAT can be obtained.

With the conventional technology, as with a protection switch, an optical level can be switched on only the reception end in the OUPSR. Thus, such a switch can be relatively easily accomplished. However, when a switch takes place in an optical level, since an expensive SAU should be used, the cost becomes high. In addition, since the operation of the SAU is slow, it takes a long time for the switching operation. In addition, the protection switch causes the number of wavelengths to increase or decrease, the operation of the optical amplifier becomes very difficult. This problem will become a bottleneck in developing the apparatus. However, when the technology according to the embodiment is used, the problem can be solved. Thus, the technology according to the embodiment is economically and technologically advantageous against the technology according to the related art.

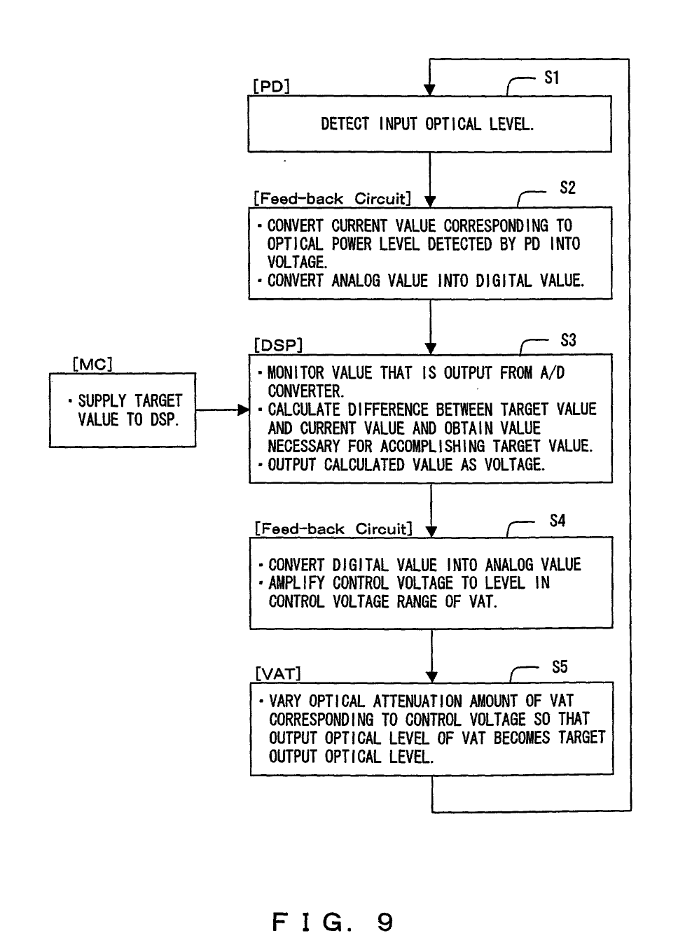

FIGS. 9 to 12 are flow charts showing a controlling process for a VAT according to an embodiment of the present invention.

A DSP (Digital Signal Processor) described in each of the flow charts is a controlling processor disposed in the feed-back circuits shown in FIGS. 6 to 8.

FIG. 9 is a flow chart showing a process for adjusting an optical power level in the structure according to an embodiment of the present invention.

At step S1, PDs assigned to optical signal components of individual wavelengths detect input optical levels thereof. At step S2, the feed-back circuit converts a current value corresponding to an optical power level detected by each PD into a voltage. The A/D converter converts the voltage as an analog value into a digital value. At step S3, the DSP of the feed-back circuit monitors the output value of the A/D converter, calculates the difference between the target value of the optical power level and the currently measured value, obtains a value necessary for accomplishing the target value, converts the obtained value to a voltage value, and outputs the voltage value. At step S4, the feed-back circuit causes a D/A converter to convert the output value of the DSP as a digital value into an analog value, amplifies the control voltage in the level of the control voltage range of the VAT, and applies the control voltage thereto. At step S5, the optical attenuation amount of the VAT is varied corresponding to the control voltage. The process is repeated until the output optical level of the VAT becomes its target output optical level. At step S3, the MS supplies the target value to the DSP.

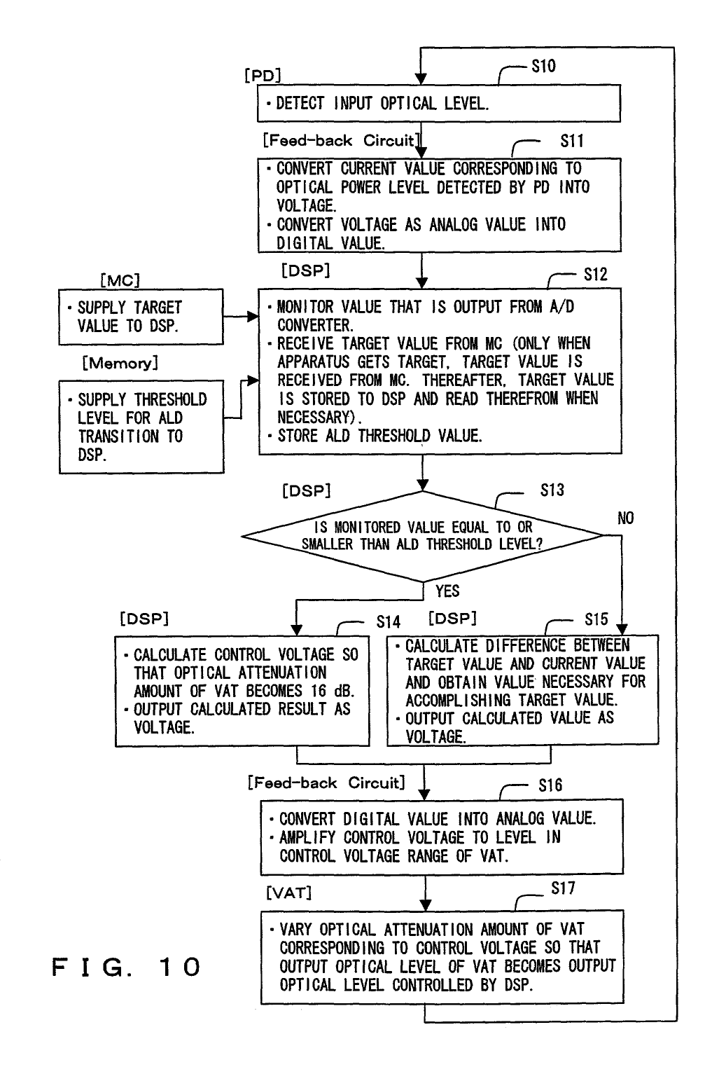

FIG. 10 is a flow chart for explaining an ALD controlling process.

At step S10, each PD detects an input optical level. At step Sll, the feed-back circuit converts a current value corresponding to the optical power level detected by the PD into a voltage value. The A/D converter converts the voltage value as an analog value into a digital value.

At step S12, the DSP monitors the output of the A/D converter and reads a target value of an optical power level from the MC. Only when the apparatus gets started, the target value is read from the MC. Thereafter, the target value is stored to the DSP so that it can be read therefrom when necessary. The DSP reads a threshold value necessary for the ALD control from the memory of the feed-back circuit. As with the target value, only when the apparatus gets started, the threshold value is read from the memory.

At step S13, the DSP determines whether or not the monitored value is equal to or smaller than the ALD threshold level. When the monitored value is not equal to nor smaller than the threshold value, the flow advances to step S15. At step S15, the DSP calculates the difference between the target value and the currently measured value, obtains a value necessary for accomplishing the target value of the optical power level, and converts the obtained value into a voltage value. Thereafter, at step S16, the feed-back circuit causes the D/A converter to convert an output voltage value of the DSP as a digital value into an analog value. The feed-back circuit converts the control voltage to the level of the control voltage range of the VAT. Thereafter, at step S17, the VAT adjusts the optical attenuation amount corresponding to the control voltage. When the determined result at step S13 represents that the monitored value is equal to or smaller than the threshold value, the flow advances to step S14. At step S14, the DSP calculates the control voltage so that the optical attenuation amount of the VAT becomes a predetermined value for example 16 dB and converts the calculated result into a voltage value. Thereafter, the flow advances to step S16. At step S16, the feed-back circuit performs the same process as that at step S4 shown in FIG. 9.

Thereafter, a loop from step S10 to step S17 is repeated until the output optical power level of the VAT becomes a target value.

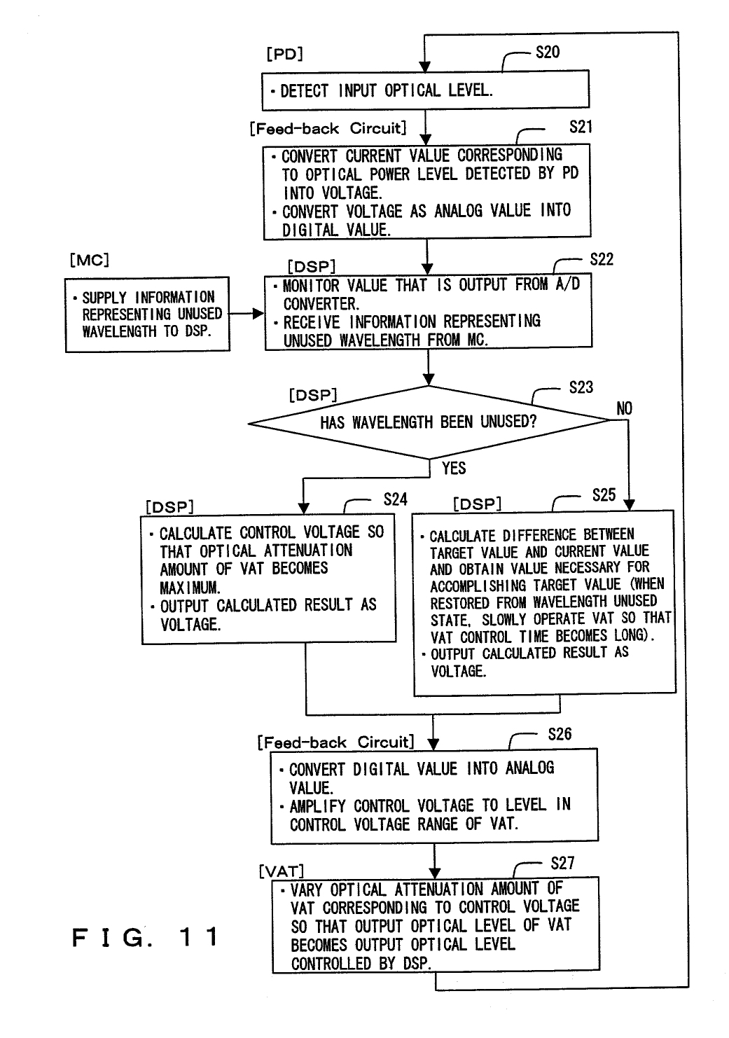

FIG. 11 is a flow chart showing a process performed in the case that a work path is switched to a protection path and the number of wavelengths of signal components that have been multiplexed varies.

At step S20, each PD detects an input optical level. At step S21, the feed-back circuit converts a current value corresponding to the optical power level detected by the PD into a voltage and causes the A/D converter to convert the voltage as an analog value into a digital value. At step S22, the DSP monitors the output value of the A/D converter and receives information that represents that a corresponding wavelength has not been used from the MC. At step S23, the DSP determines whether or not the wavelength of an optical signal component that is input to the VAT whose optical attenuation amount is to be adjusted has been unused. When the wavelength has been unused, the flow advances to step S24. At step S24, the DSP calculates a control voltage so that the optical attenuation amount of the VAT becomes maximum and outputs the calculated result as a voltage value. Thereafter, the flow advances to step S26. When the determined result at step S23 represents that the wavelength has been used, the flow advances to step S25. At step S25, the DSP calculates the difference between the target value and the currently measured value, obtains a value necessary for accomplishing the target value, and outputs the obtained value as a voltage value. Thereafter, the flow advances to step S26. At step S25, when the VAT is restored from the wavelength unused state, the DSP generates a control value so that the VAT control time becomes longer than usual (namely, the VAT is slowly operated).

At step S26, the feed-back circuit causes the D/A converter to convert the voltage value as a digital value received from the DSP into an analog value, amplifies the control voltage to the range of the control voltage range of the VAT, and outputs the amplified control voltage to the VAT. At step S27, the VAT adjusts the optical attenuation amount corresponding to the received control voltage value. Thereafter, a loop from step S20 to Step S27 is repeated until the output optical level of the VAT becomes the target value.

Only considering the embodiment of the present invention, with both a SAU and PDs, a level variation due to a pass protection may be detected by each PD. Corresponding to the detected result, the corresponding VAT may be controlled. In this case, in a regular state, the SAU may control the VAT.

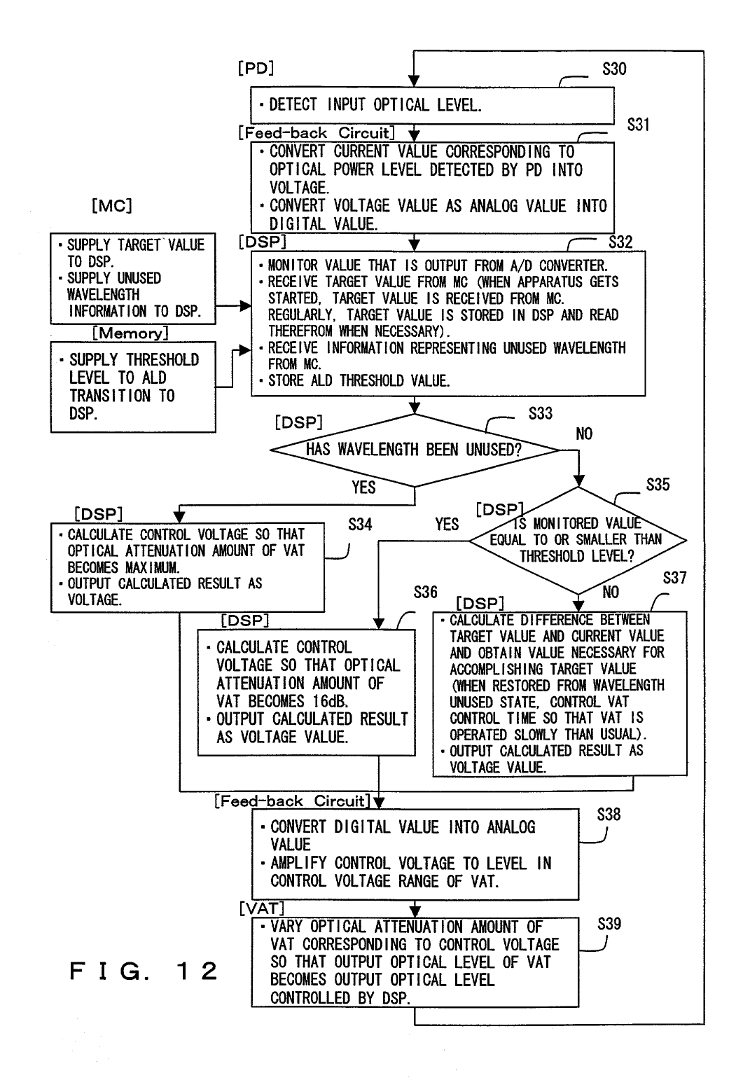

FIG. 12 is a flow chart including the processes shown in FIGS. 9 to 11.

At step S30, each PD detects an input optical level. At step S31, the feed-back circuit converts a current value corresponding to the optical power level detected by the feed-back circuit into a voltage value and causes the A/D converter to convert the voltage value as an analog value into a digital value. At step S32, the DSP monitors the output of the A/D converter, receives a target value and information that represents an unused wavelength from the MC, reads an ALD threshold value from the memory, and stores the target value and the ALD threshold value. At step S33, the DSP determines whether or not the wavelength of an optical signal component assigned to the corresponding VAT to be adjusted has been unused. When the determined result at step S33 represents that the wavelength has been unused, the flow advances to step S34. At step S34, the DSP calculates the control voltage so that the optical attenuation amount of the VAT becomes maximum and outputs the calculated result as a voltage. Thereafter, the flow advances to step S38.

When the determined result at step S33 represents that the wavelength has been used, the flow advances to step S35. At step S35, the DSP determines whether or not the monitored value is equal to or smaller than the ALD threshold level. When the determined result at step S33 represents that the monitored value is equal to or smaller than the ALD threshold value, the flow advances to step S36. At step S36, the DSP calculates a control voltage so that the optical attenuation amount of the VAT becomes a predetermined value for example 16 dB and outputs the calculated result as a voltage value. Thereafter, the flow advances to step S38.

When the determined result at step S35 represents that the monitored value is not equal to nor smaller than the ALD threshold value, the flow advances to step S37. At step S37, the DSP calculates the difference between the target value and the currently measured optical power level, obtains a value necessary for accomplishing the target value, and outputs the obtained value as a voltage value. When restored from the wavelength unused state, the DSP controls the VAT control time so that it becomes longer than usual and the operation of the VAT becomes slower than usual and outputs the voltage value. Thereafter, the flow advances to step S38.

At step S38, the feed-back circuit causes the D/A converter to convert the output voltage value of the DSP as a digital value into an analog value and amplifies the control voltage to the level of the control voltage range of the VAT. Thereafter, the flow advances to step S39. At step S39, the VAT adjusts the optical attenuation amount corresponding to the control voltage. Thereafter, a loop from step S30 to step S39 is repeated until the output optical level of the VAT becomes adequate.

According to the present invention, a tilt and so forth of a WDM optical signal can be adjusted with a low cost apparatus. In addition, a switching time for a protection path can be shortened.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. A controlling system for use with variable attenuators disposed in a WDM transmitting apparatus for adding and dropping a WDM optical signal, the controlling system comprising:
a plurality of variable attenuators for adjusting optical power levels of optical signal components of individual wavelengths demultiplexed from the WDM optical signal;
a plurality of output optical level detecting units detecting the output optical levels of the plurality of variable attenuators; and
a feed-back circuit for controlling adjustments of the optical attenuation amounts of the plurality of variable attenuators,
wherein optical signal components of individual wavelengths whose power levels have been adjusted by the plurality of variable attenuators are multiplexed and thereby a WDM optical signal is generated and transmitted.

2. The controlling system for use with the variable attenuators as set forth in claim 1,
wherein a target value is set to the feed-back circuit, the target value representing the optical power level of each of the optical signal components of individual wavelengths.

3. The controlling system for use with the variable attenuators as set forth in claim 1,
wherein when an optical signal component of a wavelength of the WDM optical signal is disconnected, the feed-back circuit sets the attenuation amount of a variable attenuator assigned to the optical signal component to a predetermined value.

4. The controlling system for use with the variable attenuators as set forth in claim 3,
wherein the predetermined value is as low as an optical signal that is transmitted from the WDM transmitting apparatus corresponding to an abrupt optical input does not destroy a WDM transmitting apparatus disposed on the next stage and as the output optical level detecting unit can detect an output optical level of the variable attenuator corresponding to the abrupt optical input.

5. The controlling system for use with the variable attenuators as set forth in claim 1,
wherein the feed-back circuit maximizes the attenuation amount of a variable attenuator assigned to an optical signal component of an unused wavelength.

6. A controlling method for use with variable attenuators disposed in a WDM transmitting apparatus for adding and dropping a WDM optical signal, the controlling method comprising:
causing a plurality of variable attenuators to adjust optical power levels of optical signal components of individual wavelengths demultiplexed from the WDM optical signal;
causing a plurality of output optical level detecting units to detect the output optical levels of the plurality of variable attenuators; and
causing a feed-back circuit to control adjustments of the optical attenuation amounts of the plurality of variable attenuators,
wherein optical signal components of individual wavelengths whose power levels have been adjusted by the plurality of variable attenuators are multiplexed and thereby a WDM optical signal is generated and transmitted.

7. The controlling method for use with the variable attenuators as set forth in claim 6,
wherein a target value is set to the feed-back circuit, the target value representing the optical power level of each of the optical signal components of individual wavelengths.

8. The controlling method for use with the variable attenuators as set forth in claim 7,
wherein when an optical signal component of a wavelength of the WDM optical signal is disconnected, the feed-back circuit sets the attenuation amount of a variable attenuator assigned to the optical signal component to a predetermined value.

9. The controlling method for use with the variable attenuators as set forth in claim 8,
wherein the predetermined value is as low as an optical signal that is transmitted from the WDM transmitting apparatus corresponding to an abrupt optical input does not destroy a WDM transmitting apparatus disposed on the next stage and as the output optical level detecting unit can detect an output optical level of the variable attenuator corresponding to the abrupt optical input.

10. The controlling method for use with the variable attenuators as set forth in claim 6,
wherein the feed-back circuit maximizes the attenuation amount of a variable attenuator assigned to an optical signal component of an unused wavelength.
